(19) United States
(12) Patent Application Publication
(10) Pub. No.: US 2023/0333249 A1
(43) Pub. Date: Oct. 19, 2023

(54) OPTICAL MEASURING SYSTEM AND METHOD FOR MEASURING A DISTANCE OR A SPEED OF AN OBJECT

(71) Applicant: ams-OSRAM International GmbH, Regensburg (DE)

(72) Inventor: Hubert HALBRITTER, Dietfurt-Toeging (DE)

(73) Assignee: ams-OSRAM International GmbH, Regensburg (DE)

(21) Appl. No.: 18/044,223

(22) PCT Filed: Aug. 23, 2021
(86) PCT No.: PCT/EP2021/073272

§ 371 Date: Mar. 7, 2023

(30) Foreign Application Priority Data
Sep. 9, 2020 (DE) 10 2020 123 561.5

(51) Int. Cl. G01S 17/58; G01S 7/4911; G01S 7/481

(52) U.S. Cl. CPC G01S 17/58; G01S 7/4911; G01S 7/4811

(57) ABSTRACT

An optical measuring system includes a multiplicity of apparatuses for emitting electromagnetic radiation, said apparatuses being configured to emit a signal simultaneously. The optical measuring system further includes a modulation device for altering a frequency of the respectively emitted electromagnetic radiation and a multiplicity of detectors which are suitable for detecting a superposition signal, which comprises the emitted electromagnetic radiation and electromagnetic radiation reflected at an object, and a measuring device, wherein the measuring device is suitable for being successively connected to each individual detector of the multiplicity of detectors.

### CROSS-REFERENCE TO RELATED APPLICATIONS

This patent application is a national stage entry from International Application No. PCT/EP2021/073272, filed on Aug. 23, 2021, published as International Publication No. WO 2022/053300 A1 on Mar. 17, 2022, and claims priority to German patent application 10 2020 123 561.5, filed Sep. 9, 2020, the entire contents of all of which are incorporated by reference herein.

### BACKGROUND

LIDAR—(“Light Detection and Ranging”) systems, in particular FMCW LIDAR systems (“frequency modulated continuous wave” LIDAR systems) are increasingly being used in vehicles, for example for autonomous driving. They are used for example to measure distances or to recognize articles. In order to be able to reliably recognize objects at a relatively great distance, laser light sources having a correspondingly high power are required.

Improvement of existing LIDAR systems is generally attempted.

In particular, efforts are made to provide a cost-effective and space-saving readout concept for such LIDAR systems.

In accordance with embodiments, the object is achieved by means of the subject matter of the independent patent claims. Advantageous further developments are defined in the dependent patent claims.

### SUMMARY

An optical measuring system comprises a multiplicity of apparatuses for emitting electromagnetic radiation, said apparatuses being configured to emit a signal simultaneously, and a modulation device for altering a frequency of the respectively emitted electromagnetic radiation. The optical measuring system furthermore comprises a multiplicity of detectors suitable for detecting a superposition signal comprising the emitted electromagnetic radiation and electromagnetic radiation reflected at an object, and a measuring device, wherein the measuring device is suitable for being successively connected to each individual detector of the multiplicity of detectors.

By way of example, the modulation device is suitable for increasing the frequency of the respectively emitted electromagnetic radiation during a first time period t1, wherein the measuring device is connected to each individual detector of the multiplicity of detectors during the first time period.

The modulation device can furthermore be suitable for decreasing the frequency of the respectively emitted electromagnetic radiation during a second time period t2, wherein the measuring device is connected to each individual detector of the multiplicity of detectors during the second time period.

By way of example, a measuring time during which the measuring device is connected to one of the multiplicity of detectors is identical for at least two of the detectors.

In accordance with further embodiments, a measuring time during which the measuring device is connected to one of the multiplicity of detectors can be selectable depending on a distance between the respective detector and the object.

In accordance with embodiments, respectively one apparatus for emitting electromagnetic radiation and one detector are integrated into a semiconductor layer stack. By way of example, the apparatus for emitting electromagnetic radiation and the detector are arranged in a manner stacked vertically one above the other in the semiconductor layer stack.

By way of example, the multiplicity of detectors can be arranged over a substrate and the measuring device is integrated into the substrate.

In accordance with embodiments, a field of view of the apparatuses for emitting electromagnetic radiation can be determined by a dimension of an aperture stop of the apparatus for emitting electromagnetic radiation.

A method for measuring a distance or a speed of an object comprises altering an emission frequency of a multiplicity of apparatuses for emitting electromagnetic radiation, and simultaneously emitting electromagnetic radiation by means of the multiplicity of apparatuses, as a result of which the electromagnetic radiation is incident on the object. The method furthermore comprises detecting a respective mixed signal by means of a multiplicity of detectors, said mixed signal comprising electromagnetic radiation reflected by the object and the electromagnetic radiation emitted by one of the multiplicity of apparatuses for emitting electromagnetic radiation, wherein a detection signal is obtained by each of the detectors. The method furthermore comprises capturing the detection signal by means of a measuring device, wherein the measuring device is successively connected to each individual detector of the multiplicity of detectors.

By way of example, the frequency of the respectively emitted electromagnetic radiation is increased during a first time period t1, wherein the measuring device is connected to each individual detector of the multiplicity of detectors during the first time period.

Furthermore, the frequency of the respectively emitted electromagnetic radiation can be reduced during a second time period t2, wherein the measuring device is connected to each individual detector of the multiplicity of detectors during the second time period.

In accordance with embodiments, a measuring time during which the measuring device is connected to one of the multiplicity of detectors is identical for at least two of the detectors.

In accordance with embodiments, a measuring time during which the measuring device is connected to one of the multiplicity of detectors is selected depending on a distance between the respective detector and the object.

### BRIEF DESCRIPTION OF THE DRAWINGS

The accompanying drawings serve to afford an understanding of exemplary embodiments of the invention. The drawings illustrate exemplary embodiments and serve together with the description for elucidating same. Further exemplary embodiments and numerous advantages from among those intended will become apparent directly from the following detailed description. The elements and structures shown in the drawings are not necessarily illustrated in a manner true to scale with respect to one another. Identical reference signs refer to identical or mutually corresponding elements and structures.

FIG. 1A is a view of an optical measuring system in accordance with embodiments.

FIG. 1B illustrates a measuring arrangement for application in the optical measuring system in accordance with embodiments.

FIG. 1C illustrates the field of view of an apparatus for emitting electromagnetic radiation.

FIG. 2A shows a temporal profile of the frequency.

FIG. 2B illustrates the temporal order of the measuring method described.

FIG. 3A shows a schematic cross-sectional view of a component of the optical measuring system.

FIG. 3B illustrates details of the component shown in FIG. 3A in accordance with embodiments.

FIG. 4 summarizes a method in accordance with embodiments.

### DETAILED DESCRIPTION

In the following detailed description, reference is made to the accompanying drawings, which form part of the disclosure and show specific exemplary embodiments for illustration purposes. In this context, a direction terminology such as “top side”, “bottom”, “front side”, “rear side”, “over”, “on”, “in front of”, “behind”, “at the front”, “at the back”, etc. relates to the orientation of the figures currently being described. Since the component parts of the exemplary embodiments can be positioned in different orientations, the direction terminology serves only for elucidation and is not restrictive in any way.

The description of the exemplary embodiments is not restrictive since other exemplary embodiments also exist and structural or logical changes can be made, without in that case departing from the scope defined by the patent claims. In particular, elements of exemplary embodiments described below can be combined with elements of other exemplary embodiments from among those described, provided that nothing to the contrary is evident from the context.

The terms “wafer” or “semiconductor material” used in the following description can encompass any semiconductor-based structure having a semiconductor surface. Wafer and structure should be understood as including doped and undoped semiconductors, epitaxial semiconductor layers, if appropriate carried by a base support, and further semiconductor structures. By way of example, a layer composed of a first semiconductor material can be grown on a growth substrate composed of a second semiconductor material, for example a GaAs substrate, a GaN substrate or an Si substrate, or composed of an insulating material, for example on a sapphire substrate.

Depending on the purpose of use, the semiconductor can be based on a direct or an indirect semiconductor material. Examples of semiconductor materials that are particularly suitable for generating electromagnetic radiation encompass, in particular, nitride semiconductor compounds, which can generate ultraviolet light, blue light or light of longer wavelength, for example, such as GaN, InGaN, AIN, AlGaN, AlGaInN, AlGaInBN, for example, phosphide semiconductor compounds, which can generate green light or light of longer wavelength, for example, such as GaAsP, AlGaInP, GaP, AlGaP, for example, and further semiconductor materials such as GaAs, AlGaAs, InGaAs, AlInGaAs, SiC, ZnSe, ZnO, Ga₂O₃, diamond, hexagonal BN and combinations of the materials mentioned. The stoichiometric ratio of the compound semiconductor materials can vary. Further examples of semiconductor materials can encompass silicon, silicon- germanium and germanium. In the context of the present description, the term “semiconductor” also includes organic semiconductor materials.

The term “substrate” generally encompasses insulating, conducting or semiconductor substrates.

The term “vertical”, as used in this description, is intended to describe an orientation which extends substantially perpendicular to the first surface of a substrate or semiconductor body. The vertical direction can correspond for example to a growth direction during the growth of layers.

The terms “lateral” and “horizontal”, as used in this description, are intended to describe an orientation or alignment which extends substantially parallel to a first surface of a substrate or semiconductor body. This can be the surface of a wafer or of a chip (die), for example.

The horizontal direction can lie for example in a plane perpendicular to a growth direction during the growth of layers.

In the context of this description, the term “electrically connected” denotes a low-resistance electrical connection between the connected elements. The electrically connected elements need not necessarily be directly connected to one another. Further elements can be arranged between electrically connected elements.

The term “electrically connected” also encompasses tunnel contacts between the connected elements.

In so far as the terms “have”, “contain”, “encompass”, “comprise” and the like are used here, they are open terms which indicate the presence of the stated elements or features, but do not exclude the presence of further elements or features. The indefinite articles and the definite articles encompass both the plural and the singular, provided that something to the contrary is not clearly evident from the context.

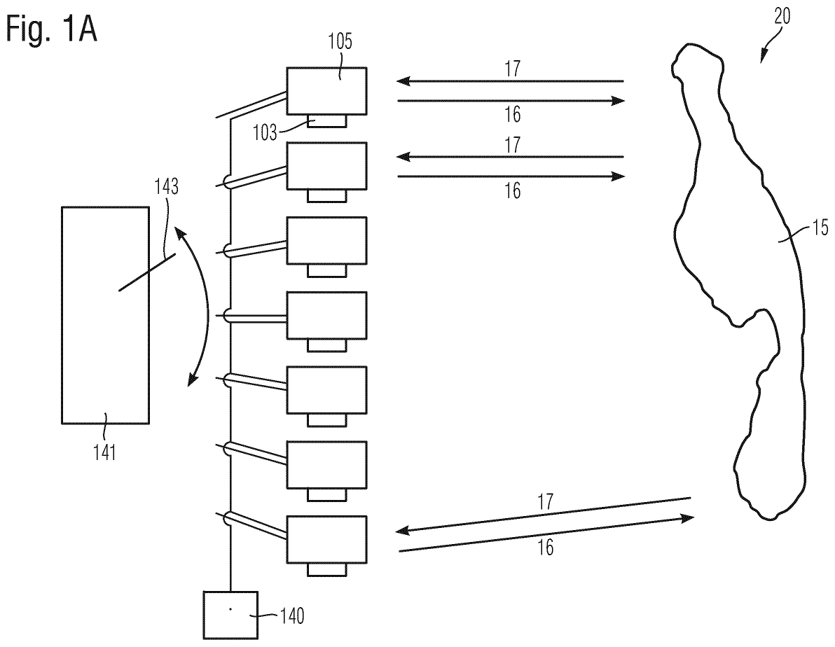

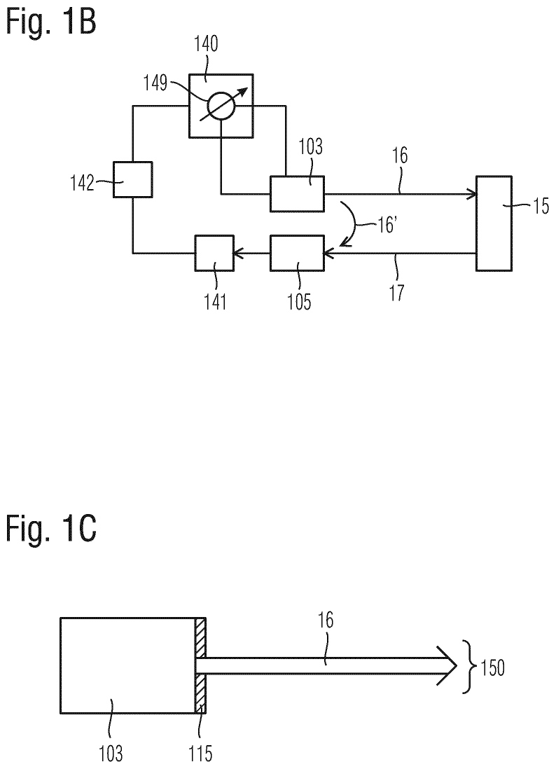

FIG. 1A shows a schematic view of an optical measuring system 20 in accordance with embodiments. The optical measuring system illustrated in FIG. 1A comprises a multiplicity of apparatuses 103 for emitting electromagnetic radiation 16. The multiplicity of apparatuses for emitting electromagnetic radiation are suitable for emitting a signal simultaneously. In accordance with further embodiments, it is also possible for only a portion of the apparatuses 103 illustrated in FIG. 1A to emit a signal simultaneously. The optical measuring system 20 furthermore has a modulation device 140. The modulation device 140 is suitable for altering a frequency of the electromagnetic radiation respectively emitted by the apparatuses 103. The optical measuring system 20 furthermore has a multiplicity of detectors 105. The detectors 105 are suitable for detecting a superposition signal comprising the emitted electromagnetic radiation 16 and electromagnetic radiation 17 reflected at an object 15. The manner of the superposition of the radiations will be explained in greater detail below with reference to FIG. 1B.

The optical measuring system furthermore comprises a measuring device 141. The measuring device 141 is suitable for being successively connected to each individual detector of the multiplicity of detectors 105. By way of example, a switch 143 can be provided, which successively connects the measuring device 141 to the individual detectors 105. By virtue of the fact that the measuring device 141 is successively connected to each individual detector of the multiplicity of detectors 105, the number of measuring devices 141 can be minimized. As a result, the optical measuring system can be realized in a space-saving, compact and cost-effective manner.

FIG. 1B schematically illustrates a measuring principle of the optical measuring system in accordance with embodiments. The measuring principle corresponds to that of an FMCW LIDAR system. A laser beam 16 is emitted by an apparatus for emitting electromagnetic radiation 103, is reflected by an object 15 and enters the detector 105 as a reflected beam 17. The reflected beam 17 is superposed with a reference beam 16′. The beam 16′ can be split off for example from the emitted beam 16, for example by partial reflection. The beam 17 is for example coherent with respect to the beam 16′ and can be superposed with the latter phase-accurately. The reference beam 16′ represents an LO (local oscillator) frequency f_{Lo}. The frequency of the reflected beam 17 is delayed on account of the propagation time difference resulting from the reflection at the object, and corresponds to the frequency fₐ. The difference between fₐ and f_{Lo} is a measure of the movement and distance of the object 15. By way of example, the distance and speed of an object can be determined from this difference. That is to say that the difference between fₐ and f_{Lo} is to be determined by the optical measuring system.

The reflected beam 17 is superposed coherently with the reference beam 16′ and detected by the detector 105. The difference frequency of the reflected beam 17 and the reference beam 16′ is determined. The detector 105 is one possible implementation of a mixer. The mixed signal can be represented as follows:

_{sig}=iₐ+i_{LO}+2\sqrt{iₐi_{LO}} cos[2π(fₐ−f_{LO})t+(φₐ−φ_{LO})] (1)

The signal detected by the detector 105 is thus a periodic signal with the frequency corresponding to the difference between fₐ and f_{LO}. The signal detected by the detector 105 is captured by a measuring device 141, for example an analogue-to-digital converter. The digital signal generated is then fed to an evaluation device 142. The frequency of the signal and thus the difference between fₐ and f_{LO} are determined.

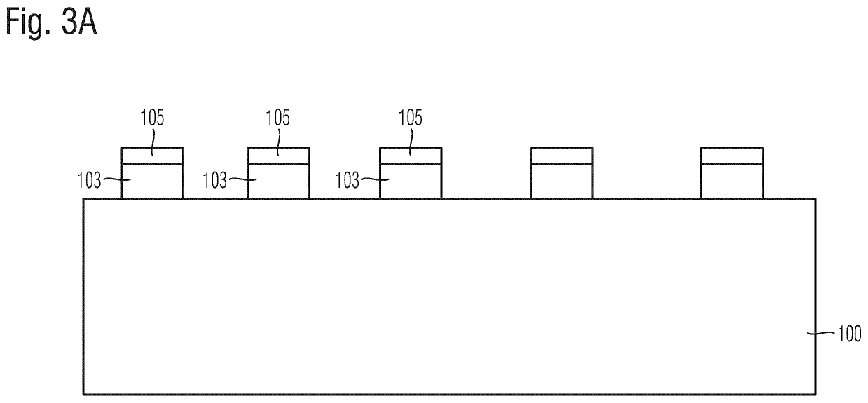

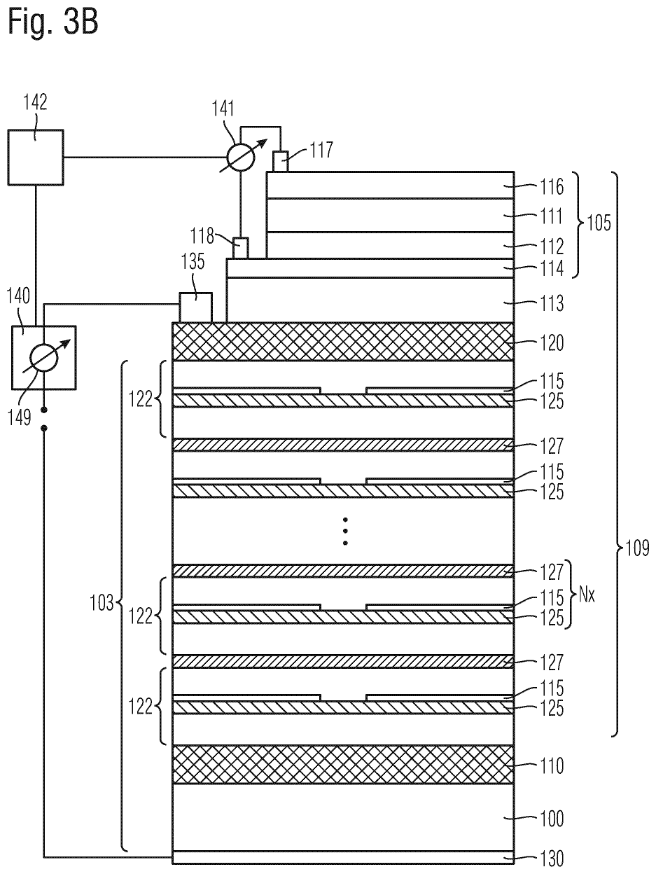

As is furthermore illustrated in FIG. 1B, the optical measuring system furthermore comprises a modulation device 140. The modulation device 140 can contain a current source 149, for example. The modulation device 140 can be suitable for modulating the current intensity impressed into each of the apparatuses for emitting electromagnetic radiation, for example in the range of a few μA. This will be explained in greater detail below with reference to FIGS. 3A and 3B.

FIG. 1C illustrates the field of view 150 of an apparatus 103 for emitting electromagnetic radiation. In accordance with embodiments, the field of view 150 is substantially determined by the dimension of the aperture stop 115 of the apparatus 103. To put it more precisely, in accordance with embodiments, there is no scanning unit that scans an angle range, whereby ultimately an area of an object 15 to be irradiated is irradiated. In accordance with embodiments, the expression “is substantially determined by the dimension of the aperture stop 115” can mean that additional lenses or other optical apparatuses for beam expanding can be provided. In contrast to a scanning unit, a lens or some other optical apparatus for beam expanding expands the laser beam without temporal retardation for example among partial beams generated. In accordance with embodiments, the multiplicity of apparatuses 103 shown in FIG. 1A comprise a high number of apparatuses 103 arranged at a corresponding distance such that it is possible to irradiate the area of the object uniformly.

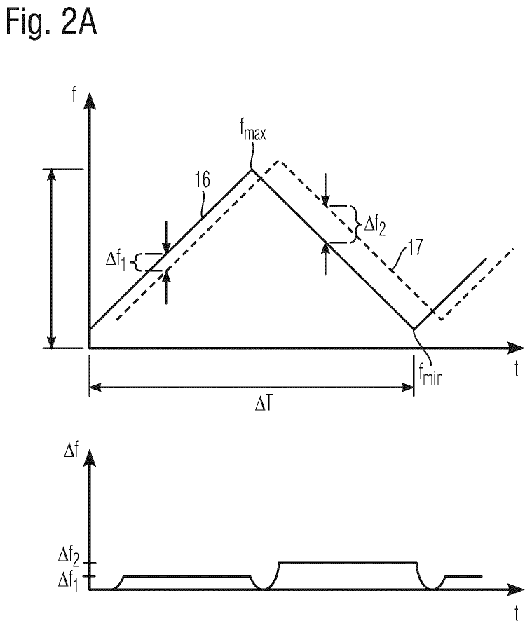

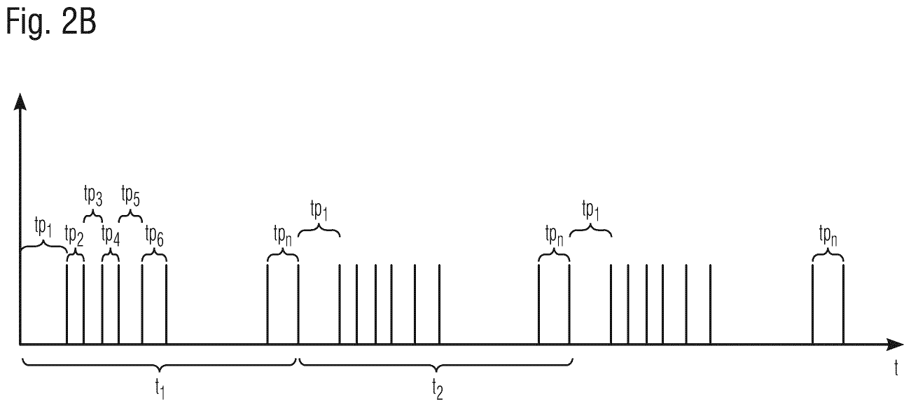

The upper part of FIG. 2A shows the temporal profile of the frequency. Here the solid line shows the frequency of the beam 16 emitted by the apparatus 103, and the dotted line shows the frequency of the beam 17 reflected by the object 15. The difference between the two frequencies is a measure of the distance and the speed of the object to be detected. As is furthermore illustrated in the upper part of FIG. 2A, the frequency of the emitted beam 16 is continuously increased by the modulation device 140 until a value fₘₐₓ is reached. The emission frequency is then continuously reduced until a frequency fₘᵢₙ is reached. In a corresponding manner with a certain temporal offset, the frequency of the reflected beam 17 follows the frequency of the emitted beam 16. Generally, a time duration in which the frequency increases and decreases again to the initial value fₘᵢₙ is ΔT.

The lower part of FIG. 2A illustrates the temporal profile of the difference frequency between the emitted beam 16 and the reflected beam 17. As can be seen, for as long as the frequency increases up to a value fₘₐₓ, this difference is smaller than in a second range, in which the frequency decreases again. By virtue of the fact that measurements are carried out both in the first range and in the second range, both speed and distance of the reflecting object 15 can be determined.

As is illustrated in FIG. 2B, the frequency of the respectively emitted electromagnetic radiation 16 is increased within a first time period t₁. The frequency of the respectively emitted electromagnetic radiation is reduced again during a second time period t₂. In accordance with embodiments, provision is then made for the measuring device 141 to be successively connected to each individual detector of the multiplicity of detectors 105 during the first time period t₁. Furthermore, the measuring device 141 is successively connected to each individual detector of the multiplicity of detectors 105 during the time period t₂.

By comparison with an arrangement in which a dedicated measuring apparatus or an analogue-to-digital converter is provided for each pixel, i.e. for each detector 105, the complexity of the measuring device can be significantly reduced in this way.

In the case of a conventional FMCW LIDAR system comprising a scanning apparatus in which the emitted laser beam “scans” the object by means of a scanning unit, for example, the first and second time periods are selected in such a way as to correspond to a measuring time of the respective detector.

In accordance with the embodiments described here, by contrast, the first and second time periods are selected in such a way as to correspond in each case to the measuring time summed over the pixels. To put it more precisely, the first time period corresponds to the measuring time for a multiplicity of pixels. Furthermore, the second time period can correspond to the measuring time for a multiplicity of pixels.

By way of example, the speed at which the frequency is altered can be adapted to the number of pixels or detectors 105 to be read. By way of example, the measuring time can be 1 μs in each case. Furthermore, depending on the distance from the object, the time duration required by the electromagnetic radiation to move to the object and back again, given a distance of 200 m, can be approximately 2 μs. In this case, a measuring time of approximately 3 μs would result for the detector of a first pixel of an arrangement. Furthermore, for each further detector 105, the measuring time would increase by 1 μs. That is to say that, in the case of a first time period of 30 μs, a total of 28 detectors can be read successively by a measuring device 141. Very fast capture of the object is possible in this way.

In comparison therewith, the measuring time would be approximately 3 μs in the case of the conventional FMCW LIDAR system comprising a scanning apparatus for each individual pixel, this measuring time including the actual measuring time and the time required by the laser beam to move to the object and back again.

By comparison with a system in which the signal for each pixel is recorded simultaneously and read out via an ADC (“analogue-to-digital converter”), and a Fourier transformation is subsequently carried out, for example, sampling rates of more than 500 MHz per pixel, for example, are required in the case of a 100 MHz FM signal. This can be achieved for example using a multiplicity of ADC converters.

As has been described, the measuring device or the analogue-to-digital converter 141 is successively connectable to each individual detector of the multiplicity of detectors 105. Accordingly, with the use of the optical measuring system described, a readout process can be carried out with just one analogue-to-digital converter or a reduced number of analogue-to-digital converters.

Since, in embodiments, as has been described above, the measuring time for a pixel can be significantly shortened, a measuring frequency can be increased to a multiple of the customary measuring frequency. In accordance with further embodiments, however, the maximum frequency can also correspond to the customary maximum frequency.

In accordance with further embodiments, the measuring duration for the individual detectors can vary. By way of example, the measuring duration can be dynamically adapted to the distance of the object. By way of example, a longer measuring time can be selected for a more closely situated object. In this way, a better resolution can be attained depending on the distance.

As is illustrated in FIG. 1A, the individual detectors 105 can be arranged in any desired positional relationship with respect to the apparatuses 103 for emitting electromagnetic radiation. By way of example, the detector 105 and the apparatus 103 for emitting electromagnetic radiation can be arranged on a common substrate 100. By way of example, the detector 105 and the apparatus 103 for emitting electromagnetic radiation can be arranged vertically one above the other. This is illustrated in FIG. 3A, for example.

In accordance with embodiments, detector 105 and apparatus 103 for emitting electromagnetic radiation can be embodied in a common semiconductor layer stack 109. In accordance with embodiments, the apparatus 103 for emitting electromagnetic radiation can be realized as a surface emitting laser diode, for example as a VCSEL (“vertical cavity surface emitting laser”). This is illustrated in FIG. 3B, for example.

FIG. 3B shows a schematic cross-sectional view of an optoelectronic semiconductor component in which the apparatus 103 for emitting electromagnetic radiation is constructed from a multiplicity of surface-emitting laser diode elements 122.

A multiplicity of individual surface-emitting laser diode elements 122 are arranged between a first resonator mirror 110 and a second resonator mirror 120. The individual surface-emitting laser diode elements 122 are connected to one another via tunnel junctions 127.

The semiconductor layer stack 109 thus has a multiplicity of active zones 125 connected to one another via tunnel junctions 127, for example. In this way, the semiconductor layer stack 109 can have more than three, for example approximately six or more than six, surface-emitting laser diode elements 122. The surface-emitting laser diode elements 122 can furthermore have suitable semiconductor layers of the first and second conductivity types, which each adjoin the active zone 125 and are connected thereto.

The tunnel junctions 127 can each have sequences of p⁺⁺-doped layers and n⁺⁺-doped layers, via which the individual surface-emitting laser diode elements 122 can in each case be connected to one another. The p⁺⁺- and n⁺⁺-doped layers are connected to the associated surface-emitting laser diode elements 122 in the reverse direction. In accordance with embodiments, the layer thicknesses of the individual semiconductor layers of the surface-emitting laser diode elements 122 are dimensioned in such a way that the tunnel junctions 127 are arranged for example at nodes of the standing wave that forms. In this way, the emission wavelength of the apparatus 103 for emitting electromagnetic radiation can be stabilized. By stacking a plurality of laser elements 122 one above another, it is possible to attain higher power densities and furthermore smaller line widths of the emitted laser beam. The sequence of very highly doped layers of the first and second conductivity types and optionally of intermediate layers constitutes a tunnel diode. The respective surface-emitting laser diode elements 122 can be connected in series using these tunnel diodes.

FIG. 3B shows an apparatus 103 for emitting electromagnetic radiation, in which a plurality of surface-emitting laser diode elements 122 are stacked one above another. In accordance with embodiments, the apparatus 103 for emitting electromagnetic radiation can also contain just a single surface-emitting laser diode element 122. The laser diode elements 122 contain aperture stops 115, for example; aperture for guiding current in the respective laser diode element. As has been explained with reference to FIG. 1C, in accordance with embodiments, the field of view 150 of the apparatus 103 for emitting electromagnetic radiation is substantially determined by the dimension of the aperture stop 115 of the apparatus 103.

FIG. 3B furthermore shows a modulation device 140 for modulating the frequency of the respectively emitted electromagnetic radiation. By way of example, the modulation device can have a current source 149. A current intensity impressed in each case into the apparatus 103 for emitting electromagnetic radiation embodied as a surface-emitting laser diode can be modulated by the modulation device 140. The modulation of the impressed current intensity gives rise to a modulation of the charge carrier density, which leads to an alteration of the refractive index in the optical resonator. The wavelength is shifted as a consequence. Furthermore, an increased charge carrier density causes a temperature increase that likewise leads to an alteration of the emission wavelength. Accordingly, the emission wavelength can be modulated in the MHz to GHz range.

It goes without saying that both detector 105 and apparatus 103 for emitting electromagnetic radiation can be realized in any other manner desired.

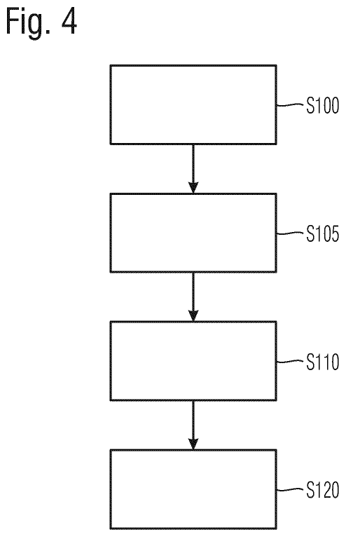

FIG. 4 summarizes a method in accordance with embodiments. A method for measuring a distance or a speed of an object comprises altering (S100) an emission frequency of a multiplicity of apparatuses for emitting electromagnetic radiation, and simultaneously emitting (S105) electromagnetic radiation by means of the multiplicity of apparatuses, as a result of which the electromagnetic radiation is incident on the object (17). The method furthermore comprises detecting (S110) a respective mixed signal by means of a multiplicity of detectors, said mixed signal comprising electromagnetic radiation reflected by the object and the electromagnetic radiation emitted by one of the multiplicity of apparatuses for emitting electromagnetic radiation, wherein a detection signal is obtained by each of the detectors. The method furthermore comprises capturing (S120) the detection signal by means of a measuring device, wherein the measuring device is successively connected to each individual detector of the multiplicity of detectors.

Although specific embodiments have been illustrated and described herein, those skilled in the art will recognize that the specific embodiments shown and described can be replaced by a multiplicity of alternative and/or equivalent configurations, without departing from the scope of protection of the invention. The application is intended to cover any adaptations or variations of the specific embodiments discussed herein. Therefore, the invention is restricted only by the claims and the equivalents thereof.

1. An optical measuring system comprising
a multiplicity of apparatuses for emitting electromagnetic radiation, said apparatuses being configured to emit a signal simultaneously;
a modulation device for altering a frequency of the respectively emitted electromagnetic radiation;
a multiplicity of detectors suitable for detecting a superposition signal comprising the emitted electromagnetic radiation and electromagnetic radiation reflected at an object, and
a measuring device, wherein the measuring device is suitable for being successively connected to each individual detector of the multiplicity of detectors.

2. The optical measuring system as claimed in claim 1, wherein the modulation device is suitable for increasing the frequency of the respectively emitted electromagnetic radiation during a first time period t1, wherein the measuring device is connected to each individual detector of the multiplicity of detectors during the first time period.

3. The optical measuring system as claimed in claim 1, wherein the modulation device is suitable for decreasing the frequency of the respectively emitted electromagnetic radiation during a second time period t2, wherein the measuring device is connected to each individual detector of the multiplicity of detectors during the second time period.

4. The optical measuring system as claimed in claim 1,
wherein a measuring time during which the measuring device is connected to one of the multiplicity of detectors is identical for at least two of the detectors.

5. The optical measuring system as claimed in claim 1, wherein a measuring time during which the measuring device is connected to one of the multiplicity of detectors is selectable depending on a distance between the respective detector and the object.

6. The optical measuring system as claimed in claim 1,
wherein respectively one apparatus for emitting electromagnetic radiation and one detector are integrated into a semiconductor layer stack.

7. The optical measuring system as claimed in claim 6, wherein the apparatus for emitting electromagnetic radiation and the detector are arranged in a manner stacked vertically one above the other in the semiconductor layer stack.

8. The optical measuring system as claimed in claim 1,
wherein the multiplicity of detectors are arranged over a substrate and the measuring device is integrated into the substrate.

9. The optical measuring system as claimed in claim 1,
wherein a field of view of the apparatuses for emitting electromagnetic radiation is determined by a dimension of an aperture stop of the apparatus for emitting electromagnetic radiation.

10. A method for measuring a distance or a speed of an object comprising:
altering an emission frequency of a multiplicity of apparatuses for emitting electromagnetic radiation;
simultaneously emitting electromagnetic radiation by means of the multiplicity of apparatuses, as a result of which the electromagnetic radiation is incident on the object;
detecting a respective mixed signal by means of a multiplicity of detectors, said mixed signal comprising electromagnetic radiation reflected by the object and the electromagnetic radiation emitted by one of the multiplicity of apparatuses for emitting electromagnetic radiation, wherein a detection signal is obtained by each of the detectors; and
capturing the detection signal by means of a measuring device, wherein the measuring device is successively connected to each individual detector of the multiplicity of detectors.

11. The method as claimed in claim 10,
wherein the frequency of the respectively emitted electromagnetic radiation is increased during a first time period t1, wherein the measuring device is connected to each individual detector of the multiplicity of detectors during the first time period.

12. The method as claimed in claim 10,
wherein the frequency of the respectively emitted electromagnetic radiation is reduced during a second time period t2, wherein the measuring device is connected to each individual detector of the multiplicity of detectors during the second time period.

13. The method as claimed in claim 10,
wherein a measuring time during which the measuring device is connected to one of the multiplicity of detectors is identical for at least two of the detectors.

14. The method as claimed in claim 10, wherein a measuring time during which the measuring device is connected to one of the multiplicity of detectors is selected depending on a distance between the respective detector and the object.
